(19) United States
(12) Patent Application Publication
(10) Pub. No.: US 2018/0184085 A1
(43) Pub. Date: Jun. 28, 2018

(54) METHOD OF DECODING VIDEO DATA, VIDEO DECODER PERFORMING THE SAME, METHOD OF ENCODING VIDEO DATA, AND VIDEO ENCODER PERFORMING THE SAME

(71) Applicant: SAMSUNG ELECTRONICS CO., LTD., Suwon-si (KR)

(72) Inventors: Jung-Yeop YANG, Seoul (KR); Ju-Won BYUN, Hwaseong-si (KR); Young-Beom JUNG, Yongin-si (KR)

(73) Assignee: SAMSUNG ELECTRONICS CO., LTD., Suwon-si (KR)

(21) Appl. No.: 15/659,845

(22) Filed: Jul. 26, 2017

(30) Foreign Application Priority Data
Dec. 23, 2016 (KR) 10-2016-0177616

(51) Int. Cl. H04N 19/115; H04N 19/44; H04N 19/176; H04N 19/154; H04N 19/107

(52) U.S. Cl. CPC H04N 19/115; H04N 19/44; H04N 19/107; H04N 19/154; H04N 19/176

(57) ABSTRACT

In a method of decoding video data in units of blocks, it is determined whether an illumination compensation (IC) operation is applied to a current block included in a current picture. IC parameters are predicted by selectively using a plurality of neighboring pixels when the IC operation is applied to the current block. The IC parameters are used for applying the IC operation to the current block. The plurality of neighboring pixels are located adjacent to the current block. A decoded block is generated by decoding an encoded block based on the predicted IC parameters. The encoded block is generated by encoding the current block.

### CROSS-REFERENCE TO RELATED APPLICATION

This application claims priority from Korean Patent Application No. 10-2016-0177616, filed on Dec. 23, 2016 in the Korean Intellectual Property Office (KIPO), the contents of which are herein incorporated by reference in their entirety.

### BACKGROUND

### 1. Technical Field

Apparatuses and methods consistent with exemplary embodiments relate generally to video processing, and more particularly to methods of decoding video data, methods of encoding video data, and video decoders and video encoders performing the methods.

### 2. Description of the Related Art

MPEG (Moving Picture Expert Group) under the ISO/IEC (International Organization for Standardization/International Electrotechnical Commission) and VCEG (Video Coding Expert Group) under the ITU-T (International Telecommunications Union Telecommunication) are leading standards of video encoding/decoding. For example, various international standards of video encoding/decoding, such as MPEG-1, MPEG-2, H.261, H.262 (or MPEG-2 Part 2), H.263, MPEG-4, AVC (Advanced Video Coding), HEVC (High Efficiency Video Coding), etc., have been established and used. AVC is also known as H.264 or MPEG-4 Part 10, and HEVC is also known as H.265 or MPEG-H Part 2. According to increasing demands for high-resolution and high-quality videos, such as high-definition (HD) videos, ultra HD (UHD) videos, etc., research has focused on video encoding/decoding for achieving improved compression performance.

### SUMMARY

Accordingly, one or more exemplary embodiments are provided to substantially obviate one or more problems due to limitations and disadvantages of the related art.

At least one example embodiment of the present disclosure provides a method of efficiently decoding encoded video data by selectively using neighboring pixel information.

At least one example embodiment of the present disclosure provides a method of efficiently encoding video data such that neighboring pixel information is selectively used when the encoded video data is decoded.

At least one example embodiment of the present disclosure provides a video decoder that performs the method of decoding video data and a video encoder that performs the method of encoding video data.

According to an aspect of an exemplary embodiment, in a method of decoding video data in units of blocks, it may be determined whether an illumination compensation (IC) operation is applied to a current block included in a current picture. IC parameters may be predicted by selectively using a plurality of neighboring pixels when the IC operation is applied to the current block. The IC parameters may be used for applying the IC operation to the current block. The plurality of neighboring pixels are located adjacent to the current block. A decoded block may be generated, via a processor, by decoding an encoded block based on the predicted IC parameters. The encoded block may be generated by encoding the current block.

According to an aspect of an exemplary embodiment, a video decoder for decoding video data in units of blocks may include a prediction module and a reconstruction module. The prediction module may determine whether an illumination compensation (IC) operation is applied to a current block included in a current picture, and predict IC parameters by selectively using a plurality of neighboring pixels when the IC operation is applied to the current block. The IC parameters may be used for applying the IC operation to the current block. The plurality of neighboring pixels may be located adjacent to the current block. The reconstruction module may decode an encoded block based on the predicted IC parameters to generate a decoded block. The encoded block may be generated by encoding the current block.

According to an aspect of an exemplary embodiment, in a method of encoding video data in units of blocks, it may be determined whether an illumination compensation (IC) operation is required for a current block included in a current picture. The IC operation may be applied to the current block by selectively using a plurality of neighboring pixels when the IC operation is required for the current block. The plurality of neighboring pixels may be located adjacent to the current block. First information representing whether the IC operation may be applied to the current block, and second information representing pixels that are included in the plurality of neighboring pixels and are used for applying the IC operation to the current block are generated. An encoded block may be generated by encoding the current block based on applying the IC operation to the current block.

According to an aspect of an exemplary embodiment, a video encoder configured to encode video data in units of blocks may include a prediction and mode decision module and a compression module. The prediction and mode decision module may determine whether an illumination compensation (IC) operation is required for a current block included in a current picture, apply the IC operation to the current block by selectively using a plurality of neighboring pixels when the IC operation is required for the current block, and generate first information representing whether the IC operation is applied to the current block, and second information representing pixels that are included in the plurality of neighboring pixels and are used for applying the IC operation to the current block. The plurality of neighboring pixels may be located adjacent to the current block. The compression module may encode the current block based on applying the IC operation to the current block to generate an encoded block.

According to an aspect of an exemplary embodiment, in a method of decoding video data in units of blocks, it may be determined whether a first operation is required for a current block included in a current picture. The first operation may represent an operation where a decoder-side derivation operation is requested. Indirect information may be predicted by selectively using a plurality of neighboring pixels based on pixel usage information when the first operation is required for the current block. The indirect information may be associated with the first operation. The plurality of neighboring pixels may be located adjacent to the current block. A decoded block may be generated by decoding an encoded block based on the predicted indirect information. The encoded block may be generated by encoding the current block.

According to an aspect of an exemplary embodiment, in a method of encoding video data in units of blocks, it may be determined whether a first operation is required for a current block included in a current picture. The first operation may represent an operation where a decoder-side derivation operation is requested. The first operation may be performed for the current block by selectively using a plurality of neighboring pixels when the first operation is required for the current block. The plurality of neighboring pixels may be located adjacent to the current block. First information representing whether the first operation is performed for the current block, and second information representing used pixels that are included in the plurality of neighboring pixels and are used for performing the first operation for the current block may be generated. An encoded block may be generated by encoding the current block based on performing the first operation for the current block.

In the method of encoding/decoding video data and the video encoder/decoder according to example embodiments, at least some of the neighboring pixels that are located adjacent to the current block may be selectively used when the decoder-side IC operation is performed, without receiving or providing the IC parameters. In addition, at least some of the neighboring pixels may be selectively used when various operations where the decoder-side derivation operation is requested are performed. Accordingly, the video encoder/decoder may achieve improved coding efficiency and a simpler structure.

### BRIEF DESCRIPTION OF THE DRAWINGS

Illustrative, non-limiting example embodiments will be more clearly understood from the following detailed description taken in conjunction with the accompanying drawings:

FIG. 1 is a flow chart illustrating a method of decoding video data according to an exemplary embodiment;

FIG. 2 is a block diagram illustrating a video decoder according to example embodiments.

FIGS. 3A, 3B, 3C and 3D are diagrams for describing a method of decoding video data according to an exemplary embodiment;

FIGS. 4, 5A, 5B and 5C are diagrams for describing a method of decoding video data according to an exemplary embodiment;

FIG. 6 is a flow chart illustrating an example of generating a decoded block in FIG. 1;

FIG. 7 is a flow chart illustrating a method of encoding video data according to an exemplary embodiment;

FIG. 8 is a block diagram illustrating a video encoder according to an exemplary embodiment;

FIG. 9 is a flow chart illustrating an example of generating an encoded block in FIG. 7.

FIG. 10 is a block diagram illustrating a video encoding and decoding system according to an exemplary embodiment;

FIG. 11 is a flow chart illustrating a method of decoding video data according to an exemplary embodiment;

FIG. 12 is a block diagram illustrating a video decoder according to an exemplary embodiment;

FIG. 13 is a flow chart illustrating a method of encoding video data according to an exemplary embodiment;

FIG. 14 is a block diagram illustrating a video encoder according to an exemplary embodiment; and

FIG. 15 is a block diagram illustrating an electronic system according to an exemplary embodiment.

### DETAILED DESCRIPTION

Various exemplary embodiments will be described more fully with reference to the accompanying drawings, in which exemplary embodiments are shown. The present disclosure may, however, be embodied in many different forms and should not be construed as limited to the embodiments set forth herein. Like reference numerals refer to like elements throughout this application. The word “exemplary” is used herein to mean “serving as an example or illustration.” Any aspect or design described herein as “exemplary” is not necessarily to be construed as preferred or advantageous over other aspects or designs.

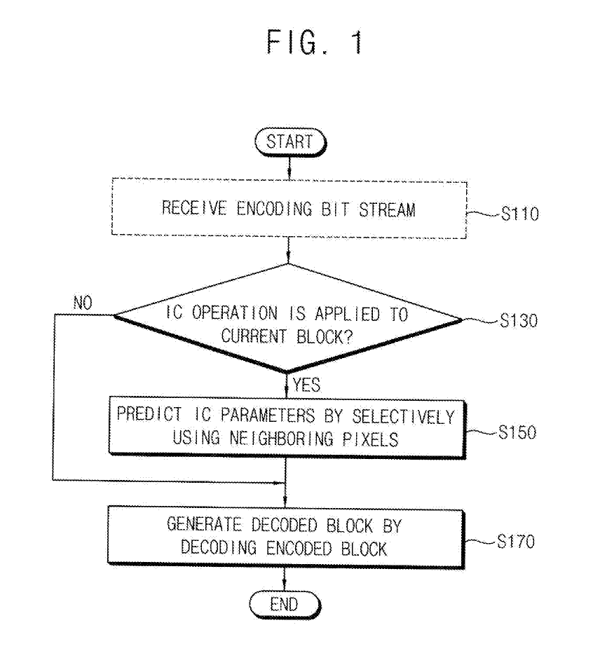

FIG. 1 is a flow chart illustrating a method of decoding video data according to an exemplary embodiment.

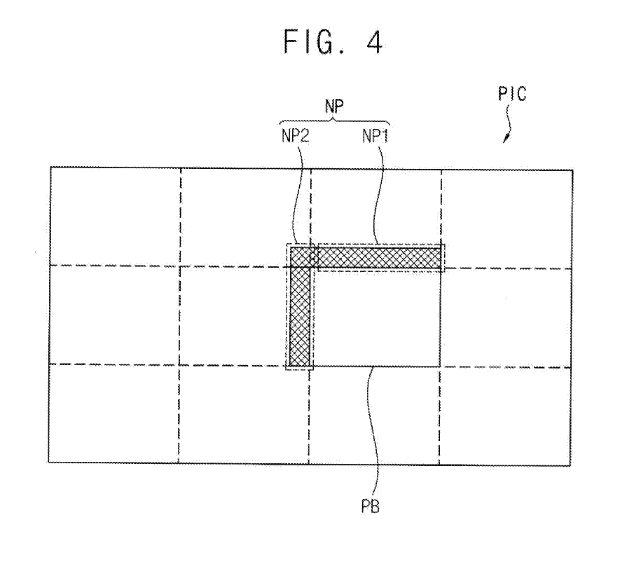

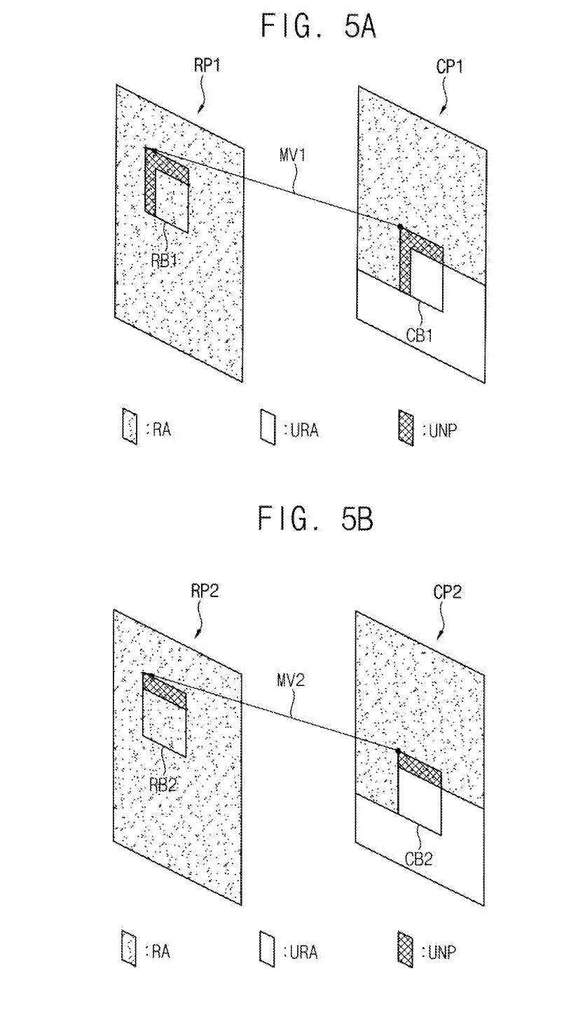

According to an aspect of an exemplary embodiment, video data may be decoded in units of blocks that are included in a picture. For example, the video data may be encoded in units of blocks depending on standards such as MPEG-2, H.261, H.262, H.263, MPEG-4, H.264, HEVC, etc. As will be described with reference to FIG. 4, a single picture may be divided into a plurality of blocks (e.g., a plurality of picture blocks).

Referring to FIG. 1, in a method of decoding video data according to an aspect of an exemplary embodiment, it is determined whether an illumination compensation (IC) operation is applied to a current block included in a current picture (S130). The IC operation represents an operation of compensating for a brightness difference and/or a color difference that occurs for the same object in images of a plurality of pictures (e.g., in a multi-view mode or in multi-view images). The brightness difference and/or the color difference occur in the multi-view images since characteristics of an imaging tool (e.g., a camera, a lens, etc.) or illuminance may vary for each of the views (e.g., frames). The IC operation may be also referred to as a luminance compensation operation, a brightness compensation operation, etc. In addition, an operation of performing the IC operation in units of the blocks may be referred to as a local IC (LIC) operation or a block-level IC operation.

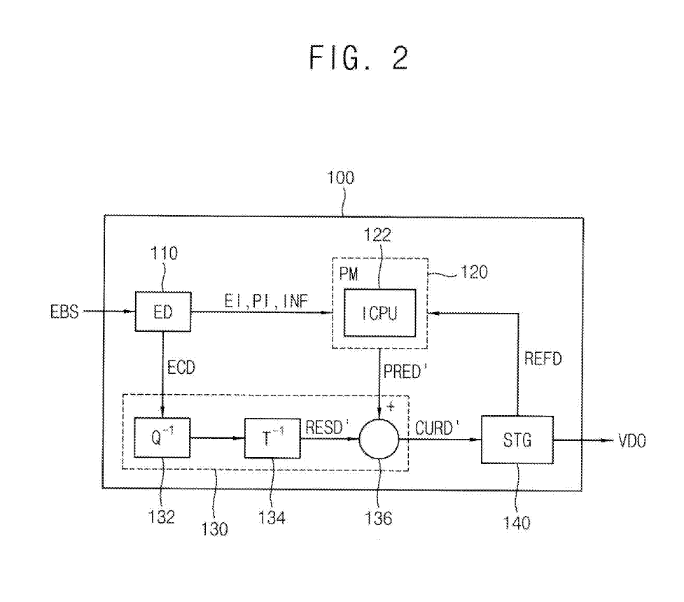

When the IC operation is applied to the current block (S130: YES), IC parameters may be predicted by selectively using a plurality of neighboring pixels that are located adjacent to the current block (S150). The IC parameters may be used for applying the IC operation to the current block. For example, the IC parameters may include compensation coefficients (e.g., for luminance or brightness adjustment) for the IC operation. The plurality of neighboring pixels will be described with reference to FIG. 4, and the IC parameters will be described with reference to FIG. 2.

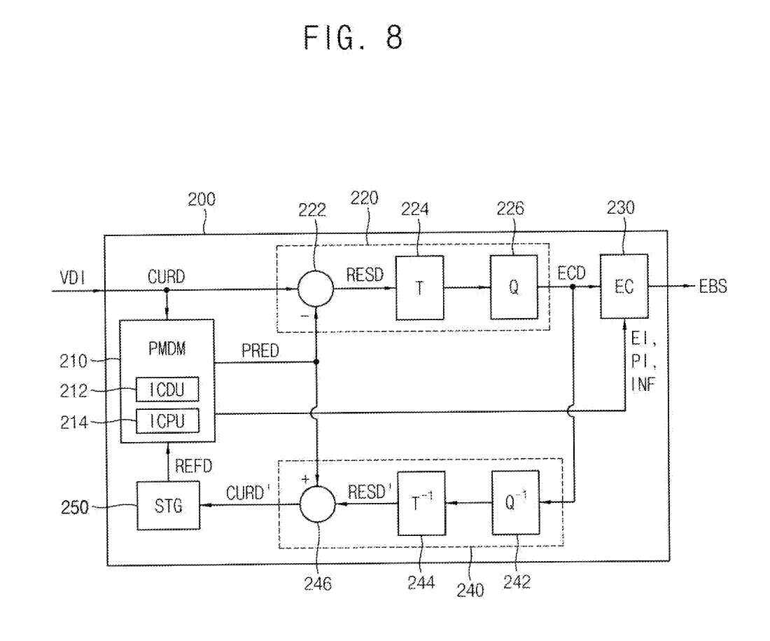

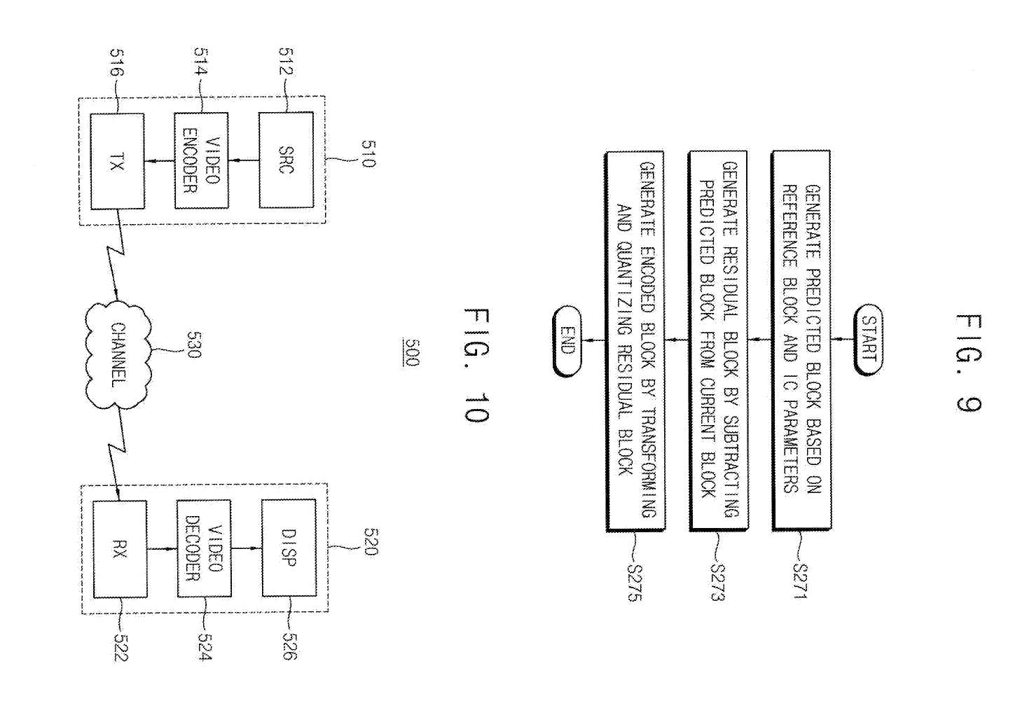

A decoded block may be generated by decoding an encoded block based on the predicted IC parameters (S170). The encoded block may be generated by encoding the current block. For example, the encoded block may be generated by a video encoder (e.g., a video encoder 200 of FIG. 8). The decoded block may be generated by encoding the current block and decoding the encoded block. For example, the decoded block may be referred to as a reconstructed or restored block and may be substantially the same as the current block.

According to an aspect of an exemplary embodiment, prior to operation S130, an encoded bit stream including the encoded block, first information, and second information may be received (S110), and then operations S130, S150 and S170 may be performed based on the encoded bit stream. The first information may be information representing whether the IC operation is applied to the current block. The second information may be information on pixels that are included in the plurality of neighboring pixels and are used for applying the IC operation to the current block. For example, operation S130 may be performed based on the first information, operation S150 may be performed based on the second information, and operation S170 may be performed based on the encoded block.

When the IC operation is not applied to the current block (S130: NO), the operation of predicting the IC parameters may be omitted (e.g., operation S150 may not be performed), and then a decoded block may be generated by decoding the encoded block without the IC parameters.

In the method of decoding the video data according to an aspect of an exemplary embodiment, when the IC operation is applied to the current block, the current block may be decoded or reconstructed without receiving or providing the IC parameters that are directly associated with the IC operation. For example, a video decoder may predict the IC parameters by itself without receiving the IC parameters and may perform the IC operation based on the predicted IC parameters, to generate the decoded block corresponding to the current block. Such operation of the video decoder may be referred to as a decoder-side IC operation (or a decoder-side IC derivation). In addition, in the method of decoding the video data, at least some of the neighboring pixels that are located adjacent to the current block may be selectively used when the decoder-side IC operation is performed. Accordingly, the video decoder that performs such method may have improved coding efficiency and a simpler structure. The operations outlined herein with reference to FIG. 1 and other figures are exemplary and can be implemented in any combination thereof, including combinations that exclude, add, or modify certain operations.

FIG. 2 is a block diagram illustrating a video decoder according to an exemplary embodiment.

Referring to FIG. 2, a video decoder 100 may include a prediction module (PM) 120 and a reconstruction module 130. The video decoder 100 may further include an entropy decoder (ED) 110 and a storage (STG) 140. The modules, units, and devices shown in FIG. 2 and other figures may be implemented with hardware (e.g., processor, memory, storage, input/output interface, communication interface, etc.), software, or a combination of both.

The video decoder 100 may perform the method of decoding the video data of FIG. 1 and may generate a decoded picture or a reconstructed picture by decoding a picture that is encoded by a video encoder (e.g., the video encoder 200 of FIG. 8). Particularly, the video decoder 100 according may perform the decoder-side IC operation.

The entropy decoder 110 may receive an encoded bit stream EBS, and may decode the encoded bit stream EBS to generate or provide (e.g., extract) data ECD corresponding to an encoded block, first information EI, second information PI, and coding information INF. For example, the encoded bit stream EBS may be generated by and provided from the video encoder. The first information IE, the second information PI, and the coding information INF may be metadata.

The encoded block may be generated by encoding a current block included in a current picture. The first information EI may be information representing whether the IC operation is applied to the current block. The second information PI may be information on pixels that are included in a plurality of neighboring pixels located adjacent to the current block and are used for applying the IC operation to the current block. The coding information INF may be information required for operations of the video decoder 100 (e.g., required for decoding the current block). For example, the coding information INF may include a prediction mode depending on a prediction operation, a result of the prediction operation, syntax elements, etc. For example, the prediction operation may include an intra prediction (or an intra-picture prediction) and an inter prediction (or an inter-picture prediction). In the intra prediction, the result of the prediction operation may include an intra prediction indicator, an intra prediction index table, etc. In the inter prediction the result of the prediction operation may include a reference picture identifier, a motion vector, etc.

The intra prediction may represent a prediction made without reference to other pictures (e.g., predicted independently of other pictures), and the inter prediction may represent a prediction made with reference to other pictures (e.g., predicted based on other pictures). At least one of the intra prediction and the inter prediction may be performed depending on a type of the current picture. For example, when the current picture (e.g., the picture encoded by the video encoder) is determined as an intra picture, only the intra prediction may be performed for the current picture. When the current picture is determined as an inter picture, only the inter prediction may be performed for the current picture, or both the intra prediction and the inter prediction may be performed for the current picture. Herein, the intra picture is a picture that does not require other pictures for decoding and may be referred to as an I picture or an I-frame. The inter picture is a picture that requires other picture(s) for decoding and may be referred to as a P picture (predictive picture or P-frame) and/or a B picture (bi-directional predictive picture or B-frame).

The prediction module 120 may determine whether the IC operation is applied to the current block, and predict IC parameters by selectively using (e.g., referencing) the plurality of neighboring pixels when the IC operation is applied to the current block. The IC parameters may be used for applying the IC operation to the current block. The prediction module 120 may include an IC performing unit (ICPU) 122. The IC performing unit 122 may determine, based on the first information EI, whether the IC operation is applied to the current block, and may predict (e.g., estimate) the IC parameters based on the second information PI.

The prediction module 120 may perform the prediction operation based on data REFD corresponding to a reference block and the predicted IC parameters to generate data PRED′ corresponding to a predicted block. For example, the IC operation may be applied to the reference block based on the predicted IC parameters, and the prediction operation may be performed based on the coding information INF and the IC-applied reference block (e.g., the reference block where the IC operation is applied). As a result, the predicted block corresponding to the IC-applied current block (e.g., the current block where the IC operation is applied) may be generated.

When the IC operation is applied to the current block, a relationship between each pixel value Pc included in the current block and a respective pixel value Pr included in the reference block may satisfy Equation 1.

Pc=α×Pr+β [Equation 1]

According to an aspect of an exemplary embodiment, the IC parameters may include α and β in Equation 1. The α and β in Equation 1 may be referred to as a scaling factor and an offset, respectively.

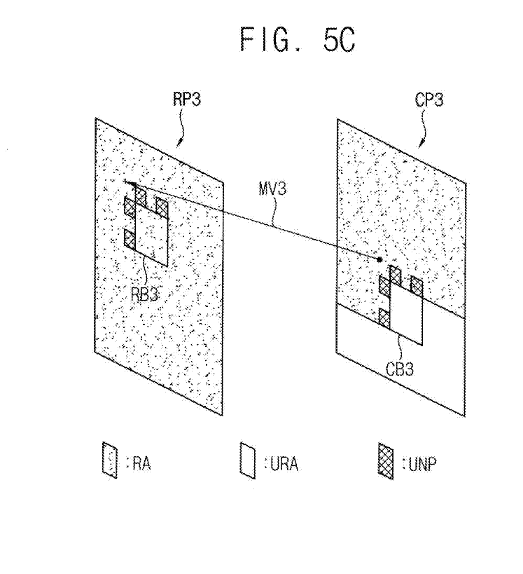

The reference block may be included in a reference picture that was already decoded by the video decoder 100 and has been stored in the storage 140. In addition, the reference block may correspond to the current block. A relationship between the current block (or the current picture) and the reference block (or the reference picture) will be described with reference to FIGS. 5A, 5B and 5C.

The prediction module 120 may further include an intra prediction unit (or an intra-picture prediction unit) that performs the intra prediction, and an inter prediction unit (or an inter-picture prediction unit) that performs the inter prediction. The intra prediction unit may perform the intra prediction to generate the predicted block without referring to other pictures (e.g., frames). The inter prediction unit may perform the inter prediction to generate the predicted block by referring to the previous picture in a case of the P picture and by referring to the previous and next pictures in a case of the B picture. For example, the inter prediction unit may include a motion compensation unit, and then the IC performing unit 122 may be included in the motion compensation unit.

The reconstruction module 130 may decode the encoded block based on the predicted IC parameters (e.g., based on the predicted block that is generated based on the predicted IC parameters) to generate data CURD′ corresponding to a decoded block. The decoded block may be substantially the same as the current block.

The reconstruction module 130 may include an inverse quantization unit (Q¹) 132, an inverse transform unit (T⁻¹) 134 and an adder 136. The encoded block may be inverse-quantized and inverse-transformed by the inverse quantization unit 132 and the inverse transform unit 134, respectively, to generate data RESD′ corresponding to a residual block. The adder 136 may add the residual block to the predicted block to generate the decoded block.

The restored data CURD′ corresponding to the decoded block may be stored in the storage 140. The data CURD′ may be used as another reference picture for encoding other pictures, or may be provided to a display device (e.g., a display device 526 in FIG. 10) as output video data VDO.

The video decoder 100 may further include a deblocking filter for in-loop filtering and/or a sample adaptive offset (SAO) filter located between the adder 136 and the storage 140.

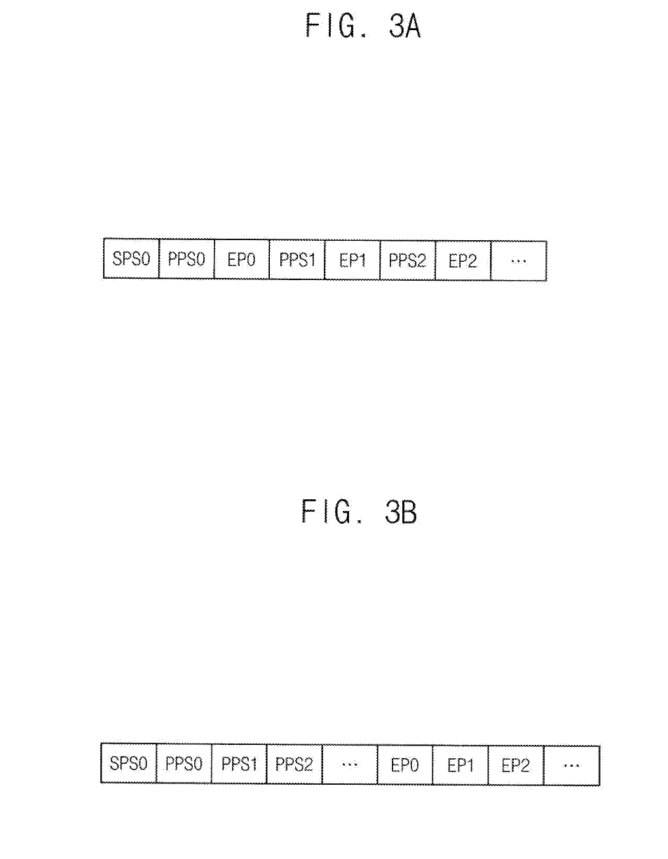

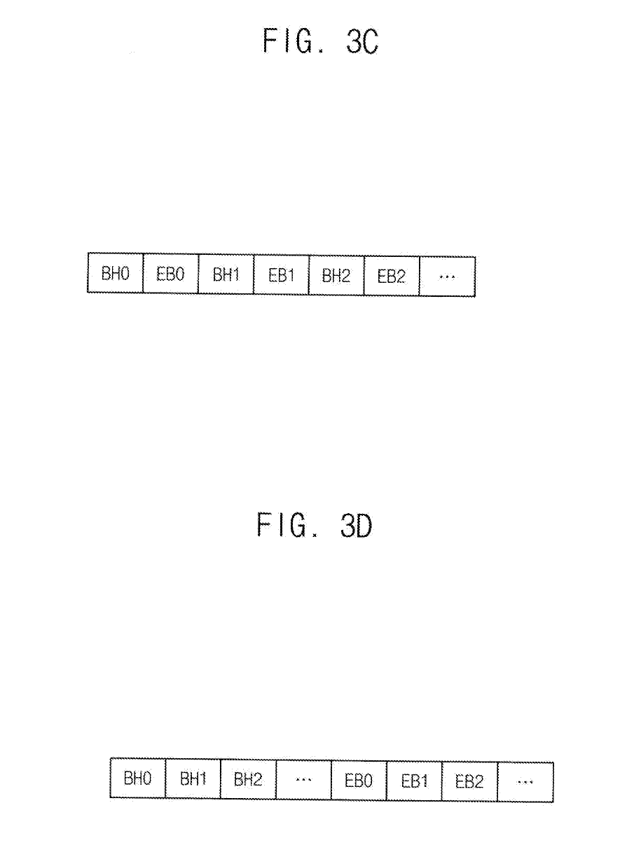

FIGS. 3A, 3B, 3C and 3D are diagrams for describing a method of decoding video data according to example embodiments. FIGS. 3A, 3B, 3C and 3D illustrate examples of an encoded bit stream (e.g., the encoded bit stream EBS in FIGS. 2 and 8).

Referring to FIGS. 3A and 3B, an encoded bit stream may include a sequence parameter set SPS0, a plurality of picture parameter sets PPS0, PPS1, PPS2, etc., and a plurality of encoded pictures EP0, EP1, EP2, etc.

A sequence parameter set may include common coding information for all encoded pictures that are included in a single picture sequence (e.g., in the same picture sequence). A picture parameter set may include common coding information for a single picture (e.g., for all encoded blocks included in the same picture). For example, each of the plurality of picture parameter sets PPS0, PPS1 and PPS2 may correspond to a respective one of the plurality of encoded pictures EP0, EP1 and EP2.

As illustrated in FIGS. 3A and 3B, the sequence parameter set SPS0 may be arranged or disposed at the very front of a single picture sequence. For example, as illustrated in FIG. 3A, each picture parameter set and a respective encoded picture may be alternately arranged or disposed subsequent to the sequence parameter set SPS0. As another example, as illustrated in FIG. 3B, all of the picture parameter sets may be arranged or disposed subsequent to the sequence parameter set SPS0, and then all of the encoded pictures may be arranged or disposed subsequent to the picture parameter sets. Although not illustrated in FIGS. 3A and 3B, more than two encoded pictures may correspond to a single picture parameter set.

The first and second information EI and PI in FIG. 2 that are required for the decoder-side IC operation may be included in a picture parameter set or a sequence parameter set representing coding information of the current picture. For example, if the encoded picture EP0 is the current picture, the first and second information EI and PI may be included in the picture parameter set PPS0 or the sequence parameter set SPS0 representing coding information of the current picture EP0.

Referring to FIGS. 3C and 3D, a single encoded picture included in an encoded bit stream may include a plurality of block headers BH0, BH1, BH2, etc., and a plurality of encoded blocks EB0, EB1, EB2, etc.

A block header may include coding information for a single encoded block. For example, each of the plurality of block headers BH0, BH1 and BH2 may correspond to a respective one of the plurality of encoded blocks EB0, EB1 and EB2. For example, as illustrated in FIG. 3C, each block header and a respective encoded block may be alternately arranged or disposed in a single encoded picture. As another example, as illustrated in FIG. 3D, all of the block headers may be arranged or disposed at the very front of a single encoded picture, and then all of the encoded blocks may be arranged or disposed subsequent to the block headers. Although not illustrated in FIGS. 3C and 3D, more than two encoded blocks may correspond to a single block header.

In some example embodiments, the first and second information EI and PI in FIG. 2 that are required for the decoder-side IC operation may be included in a block header representing coding information of the current block. For example, if the encoded block EB0 is the current block, the first and second information EI and PI may be included in the block header BH0 representing coding information of the current block EB0.

FIGS. 4, 5A, 5B and 5C are diagrams for describing a method of decoding video data according to an exemplary embodiment. FIG. 4 illustrates a relationship between a picture and a block included in the picture. FIGS. 5A, 5B and 5C illustrate examples of using neighboring pixels for performing the decoder-side IC operation.

Referring to FIG. 4, a single picture PIC may be divided into a plurality of blocks PB (e.g., a plurality of picture blocks). For example, the plurality of blocks PB may have the same size, and may not overlap one another. In an example of FIG. 4, the picture PIC may be divided into twelve blocks PB. Each of the plurality of blocks PB may include a plurality of pixels (e.g., 16×16 pixels).

According to an aspect of an exemplary embodiment, the picture PIC may correspond to a frame in a progressive scan scheme or a field in an interlaced scan scheme. In some example embodiments, each of the plurality of blocks PB may be referred to as a macroblock in the H.264 standard. Alternatively, each of the plurality of blocks PB may be referred to as a coding unit (CU) in the HEVC standard. A sub-block in each macroblock or each CU, and/or each prediction unit (PU) or transform unit (TU) in the HEVC standard may correspond to each of the plurality of blocks PB.

A plurality of neighboring pixels NP that are located adjacent to a single block may be included in the picture PIC. For example, the plurality of neighboring pixels NP may include first neighboring pixels NP1 and second neighboring pixels NP2. The first neighboring pixels NP1 may be located adjacent to a first side (e.g., an upper side) of the block, and the second neighboring pixels NP2 may be located adjacent to a second side (e.g., a left side) of the block.

At least some of the plurality of neighboring pixels NP may be selectively used for performing the decoder-side IC operation.

In some example embodiments, the second information PI in FIG. 2 that is required for the decoder-side IC operation may include first usage information representing whether the first neighboring pixels NP1 are used for applying the IC operation to the current block, and second usage information representing whether the second neighboring pixels NP2 are used for applying the IC operation to the current block. In other example embodiments, the second information PI in FIG. 2 that is required for the decoder-side IC operation may include number information representing the number of used pixels that are used for applying the IC operation to the current block, and location information representing locations of the used pixels that are used for applying the IC operation to the current block.

Referring to FIGS. 5A, 5B and 5C, “RA” represents a first area where a decoding operation is successfully completed, “URA” represents a second area where the decoding operation is not performed yet, and “UNP” represents neighboring pixels that are used for the decoder-side IC operation. In FIGS. 5A, 5B and 5C, a decoding operation for reference pictures RP1, RP2 and RP3 may be fully completed, a decoding operation for current pictures CP1, CP2 and CP3 may be partially completed only from first blocks to previous blocks immediately prior to current blocks CB1, CB2 and CB3. Since the IC operation is an operation based on the inter prediction, reference blocks RB1, RB2 and RB3 in the reference pictures RP1, RP2 and RP3 that correspond to the current blocks CB1, CB2 and CB3 in the current pictures CP1, CP2 and CP3 may be referred for the decoder-side IC operation based on motion vectors MV1, MV2 and MV3.

In some example embodiments, as illustrated in FIG. 5A, when the IC operation is to be applied to the current block CB1, all of the first neighboring pixels NP1 in FIG. 4 and all of the second neighboring pixels NP2 in FIG. 4 may be used to predict IC parameters that are used for applying the IC operation to the current block CB1.

In other example embodiments, as illustrated in FIG. 5B, when the IC operation is to be applied to the current block CB2, IC parameters that are used for applying the IC operation to the current block CB2 may be predicted only based on all of the first neighboring pixels NP1 in FIG. 4.

In still other example embodiments, as illustrated in FIG. 5C, when the IC operation is to be applied to the current block CB3, IC parameters that are used for applying the IC operation to the current block CB3 may be predicted based on some of the first neighboring pixels NP1 in FIG. 4 and some of the second neighboring pixels NP2 in FIG. 4.

Although not illustrated in FIGS. 5A, 5B and 5C, IC parameters that are used for applying the IC operation to the current block may be predicted only based on some of the first neighboring pixels NP1 in FIG. 4.

In examples of FIGS. 5A and 5B, the second information PI in FIG. 2 may include the first usage information and the second usage information, or may include the number information and the location information. In an example of FIG. 5C, the second information PI in FIG. 2 may include the number information and the location information.

Although FIGS. 4, 5A, 5B and 5C illustrate examples where the plurality of neighboring pixels are located adjacent to the upper side and the left side of the current block based on an example where a plurality of blocks in a single picture are coded (e.g., encoded and/or decoded) from a first row to a last row and from a leftmost block to a rightmost block in the same row, the number and locations of the plurality of neighboring pixels may vary according to example embodiments (e.g., depending on a coding order and/or a coding scheme).

Table 1 and Table 2 represent examples of a syntax table for performing the decoder-side IC operation according to example embodiments. For example, each of Table 1 and Table 2 may represent an example where the second information PI may include the first usage information and the second usage information.

TABLE 1

Descriptor

pic_parameter_set_rbsp( ) {

...

if ( lic_pps_enabled_flag ) {

| | |
|---|---|
| lic_pps_up_pixel_enabled_flag | u(1) |
| lic_pps_left_pixel_enabled_flag | u(1) |

}

...

TABLE 2

Descriptor

coding_unit( x0, y0, log2CbSize ) {

...

if ( lic_pps_enabled_flag && CuPredMode[
x0 ][ y0 ] != MODE_INTRA )

| | |
|---|---|
| lic_cu_enable_flag | u(1) |

if ( lic_cu_enabled_flag &&
lic_pps_up_pixel_enable_flag )

| | |
|---|---|
| lic_cu_up_pixel_enabled_flag | u(1) |

if (lic_cu_enabled_flag &&
lic_pps_left_pixel_enable_flag ) {

| | |
|---|---|
| lic_cu_left_pixel_enabled_flag | u(1) |

...

Table 1 may represent an example where the first and second information EI and PI are included in a picture parameter set, and Table 2 may represent an example where the first and second information EI and PI are included in a block header. Each of the first and second information EI and PI may include at least one flag value. For example, if a flag value “lic_pps_enabled_flag” in Table 1 or a flag value “lic_cu_enabled_flag” in Table 2 that represents the first information EI is “1,” it may represent that the IC operation is applied to the current block. If a flag value “lic_pps_up_pixel_enabled_flag” in Table 1 or a flag value “lic_cu_up_pixel_enabled_flag” in Table 2 that represents the first usage information included in the second information PI is “1,” it may represent that all of the first neighboring pixels NP1 are used for applying the IC operation to the current block. If a flag value “lic_pp_s_left_pixel_enabled_flag” in Table 1 or a flag value “lic_cu_left_pixel_enabled_flag” in Table 2 that represents the second usage information included in the second information PI is “1,” it may represent that all of the second neighboring pixels NP2 are used for applying the IC operation to the current block.

Table 3 and Table 4 represent other examples of a syntax table for performing the decoder-side IC operation according to an aspect of an exemplary embodiment. For example, each of Table 3 and Table 4 may represent an example where the second information PI may include the number information and the location information.

TABLE 3

Descriptor

pic_parameter_set_rbsp( ) {

...

if ( lic_pps_enabled_flag ) {

| | |
|---|---|
| lic_pps_nbr_pixel_num_minus1 | ae(v) |
| for ( i = 0; i < lic_pps_nbr_pixel_num_minus1; | |
| i++ ) { | |

| | |
|---|---|
| lic_pps_pixel_position[ 0 ] | ae(v) |
| lic_pps_pixel_position[ 1 ] | ae(v) |

}

}

...

TABLE 4

Descriptor

coding_unit( x0, y0, log2CbSize ) {

. . .

if ( lic_pps_enabled_flag && CuPredMode[
x0 ][ y0 ] != MODE_INTRA )

| | |
|---|---|
| lic_cu_enable flag | u(1) |

if ( lic_cu_enabled_flag ) {

| | |
|---|---|
| lic_cu_nbr_pixel_num_minus1 | ae(v) |
| for ( i = 0; i < lic_pps_nbr_pixel_num_minus1; | |
| i++ ) { | |

| | |
|---|---|
| lic_cu_pixel_position[ 0 ] | ae(v) |
| lic_cu_pixel_position[ 1 ] | ae(v) |

}

}

. . .

Table 3 may represent an example where the first and second information EI and PI are included in a picture parameter set, and Table 4 may represent an example where the first and second information EI and PI are included in a block header. Each of the first and second information EI and PI may include at least one flag value. For example, a flag value “lic_pps_nbr_pixel_num_minus1” in Table 3 and a flag value “lic_cu_nbr_pixel_num_minus1” in Table 4 may represent the number information included in the second information PI. Flag values “lic_pps_pixel_position[0]” and “lic_pps_pixel_position[1]” in Table 3 and flag values “lic_cu_pixel_position[0]” and “lic_cu_pixel_position[1]” in Table 4 may represent the location information included in the second information PI.

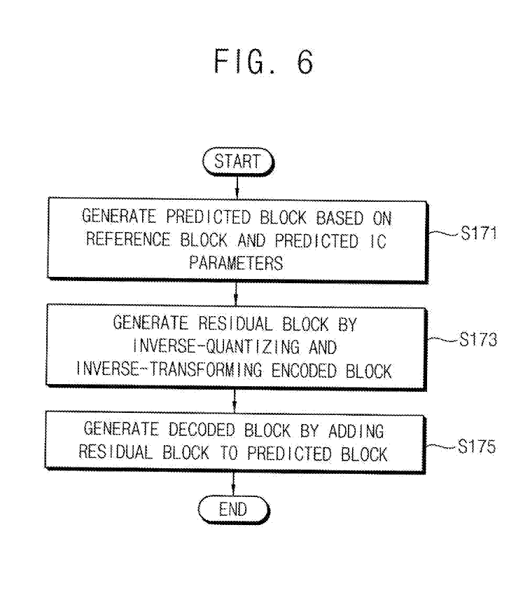

FIG. 6 is a flow chart illustrating an example of generating a decoded block in FIG. 1.

Referring to FIGS. 1 and 6, to generate the decoded block by decoding the encoded block based on the predicted IC parameters (e.g., in S170), a predicted block may be generated by performing a prediction operation based on a reference block and the predicted IC parameters (S171). The reference block may be included in a reference picture and may correspond to the current block. For example, the IC operation may be applied to the reference block based on the predicted IC parameters, and the prediction operation may be performed based on the IC-applied reference block. As a result, the predicted block corresponding to the IC-applied current block may be generated.

A residual block may be generated by inverse-quantizing and inverse-transforming the encoded block (S173), and the decoded block may be generated by adding the residual block to the predicted block (S175).

In some example embodiments, operation S171 may be performed by the prediction module 120 in FIG. 2, and operations S173 and S175 may be performed by the reconstruction module 130 in FIG. 2.

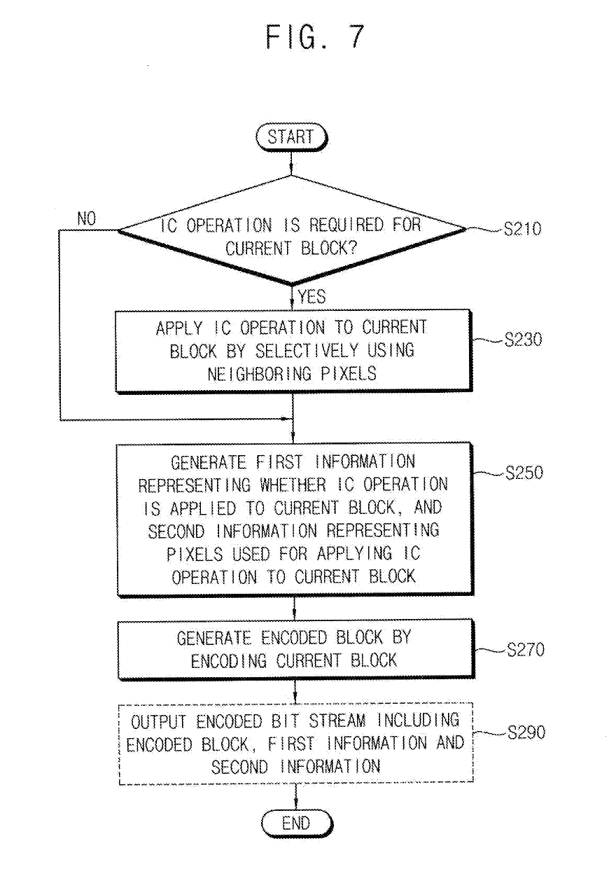

FIG. 7 is a flow chart illustrating a method of encoding video data according to an exemplary embodiment.

In this exemplary embodiment, video data is encoded in units of blocks that are included in a picture. As described with reference to FIG. 4, a single picture may be divided into a plurality of blocks (e.g., a plurality of picture blocks).

Referring to FIG. 7, in a method of encoding video data, it may be determined whether an illumination compensation (IC) operation is required for a current block included in a current picture (S210). Detailed operation of determining whether the IC operation is required for the current block will be described with reference to FIG. 8.

When it is determined that the IC operation is required for the current block (S210: YES), the IC operation may be applied to the current block by selectively using a plurality of neighboring pixels (S230). The plurality of neighboring pixels may be located adjacent (e.g., up, down, left, right) to the current block. For example, IC parameters that are used for applying the IC operation to the current block may be set. For example, the IC parameters may include a scaling factor α and an offset β in Equation 1.

First information and second information may be generated (S250), and an encoded block may be generated by encoding the current block based on applying the IC operation to the current block (S270). The first information may be information representing whether the IC operation is applied to the current block. The second information may be information on pixels that are included in the plurality of neighboring pixels and are used for applying the IC operation to the current block. As described with reference to FIGS. 3A, 3B, 3C, and 3D, the first and second information may be included in a picture parameter set or a sequence parameter set, or may be included in a block header. As described with reference to Tables 1, 2, 3 and 4, the first and second information may include at least one flag value. The second information may include first usage information and second usage information for the neighboring pixels, or may include number information and location information for the neighboring pixels.

According to an aspect of an exemplary embodiment, after operation S270, an encoded bit stream including the encoded block, the first information and the second information may be output (S290). The encoded bit stream may be provided to a video decoder (e.g., the video decoder 100 of FIG. 2) and may be decoded by the video decoder and based on the method of FIG. 1.

When it is determined that the IC operation is not required for the current block (S210: NO), the operation of applying the IC operation to the current block may be omitted (e.g., operation S230 need not be performed), and then an encoded block may be generated by encoding the current block where the IC operation is not applied thereto.

In the method of encoding the video data according to, when the IC operation is required for the current block, the IC operation may be applied to the current block by selectively using at least some of the plurality of neighboring pixels that are located adjacent to the current block. Then, the IC parameters that are directly associated with the IC operation may not be output or provided, and information associated with the neighboring pixels may only be output such that the decoder-side IC operation is performed by the video decoder. Since at least some of the neighboring pixels are selectively used when the IC operation is applied to the current block, the video encoder that performs such method according to example embodiments may have improved coding efficiency and a simpler structure.

FIG. 8 is a block diagram illustrating a video encoder according to an exemplary embodiment.

Referring to FIG. 8, a video encoder 200 may include a prediction and mode decision module (PMDM) 210 and a compression module 220. The video encoder 200 may further include an entropy encoder (EC) 230, a reconstruction module 240 and a storage 250.

The video encoder 200 may perform the method of encoding the video data of FIG. 7, and may generate information for the decoder-side IC operation that is performed by a video decoder (e.g., the video decoder 100 of FIG. 2).

The video encoder 200 may receive input video data VDI from a video source (e.g., a video source 512 in FIG. 10). The input video data VDI may include data CURD corresponding to a current block included in a current picture.

The prediction and mode decision module 210 may determine whether the IC operation is required for a current block included in a current picture based on data CURD corresponding to the current block and data REFD corresponding to a reference block. The reference block may be included in a reference picture and may correspond to the current block. When the IC operation is required for the current block, the prediction and mode decision module 210 may apply the IC operation to the current block by selectively using a plurality of neighboring pixels that are located adjacent to the current block. The prediction and mode decision module 210 may generate first information EI and second information PI that are indirectly associated with the IC operation. The first information EI may be information representing whether the IC operation is applied to the current block. The second information PI may be information on pixels that are included in the plurality of neighboring pixels and are used for applying the IC operation to the current block.

The prediction and mode decision module 210 may include an IC determining unit (ICDU) 212 and an IC performing unit (ICPU) 214.

The IC determining unit 212 may determine whether the IC operation is required for the current block and may generate the first information EI. For example, the IC determining unit 212 may check every possible scenario (e.g., combinations of sub-blocks in the current block, whether the IC operation is required for each sub-block, etc.) associated with the current block and may perform rate distortion optimization (RDO), and thus it may be determined whether the IC operation is required for the current block. The IC performing unit 214 may set IC parameters that are used for applying the IC operation to the current block by selectively using the plurality of neighboring pixels and may generate the second information PI. As described with reference to FIGS. 1 and 2, when an encoded block that is generated by encoding the current block is to be decoded, the IC parameters may be predicted by the video decoder based on the second information PI.

The prediction and mode decision module 210 may perform a prediction operation based on the reference block and the IC parameters to generate data PRED corresponding to a predicted block. For example, the IC operation may be applied to the reference block based on the IC parameters, and the prediction operation may be performed based on the IC-applied reference block (e.g., the reference block where the IC operation is applied thereto). As a result, the predicted block corresponding to the IC-applied current block (e.g., the current block where the IC operation is applied thereto) may be generated. The prediction and mode decision module 210 may generate coding information INF that includes a prediction mode depending on the prediction operation, a result of the prediction operation, syntax elements, etc.

As described with reference to FIG. 2, the prediction operation may include an intra prediction and an inter prediction, and the prediction and mode decision module 210 may perform the intra prediction and/or the inter prediction depending on a type of a picture. The prediction and mode decision module 210 may determine an encoding mode based on a result of at least one of the intra prediction and the inter prediction. The prediction and mode decision module 210 may include an intra prediction unit that performs the intra prediction, and an inter prediction unit that performs the inter prediction. For example, the inter prediction unit may include a motion estimation unit that generates a motion vector, and a motion compensation unit. The IC determining unit 212 may be included in the motion estimation unit, and the IC performing unit 214 may be included in the motion compensation unit.

The compression module 220 may encode the current block by applying the IC operation to the current block to generate data ECD corresponding to an encoded block. The compression module 220 may include a subtractor 222, a transform unit (T) 224, and a quantization unit (Q) 226. The subtractor 222 may subtract the predicted block from the current block to generate data RESD corresponding to a residual block. The transform unit 224 and the quantization unit 226 may transform and quantize the residual block, respectively, to generate the encoded block.

According to an aspect of an exemplary embodiment, the transform unit 224 may perform spatial transform with respect to the residual block. The spatial transform may be one of discrete cosine transform (DCT), wavelet transform, etc. The transform coefficients, such as DCT coefficients, the wavelet coefficients, etc., may be obtained as a result of the spatial transform.

Through the quantization, such as scalar quantization, vector quantization, etc., the transform coefficients may be grouped into discrete values. For example, based on the scalar quantization, each transform coefficient may be divided by the corresponding value in the quantization table and the quotient may be rounded off to the integer.

In the case of adopting the wavelet transform, embedded quantization, such as embedded zerotrees wavelet algorithm (EZW), set partitioning in hierarchical trees (SPIHT), embedded zeroblock coding (EZBC), etc., may be used. Such encoding process before entropy coding may be referred to as a loss encoding process.

The entropy encoder 230 may perform a lossless encoding with respect to the data ECD corresponding to the encoded block, the first information EI, the second information PI, and the coding information INF to generate an encoded bit stream EBS. The lossless encoding may be arithmetic coding such as context-adaptive binary arithmetic coding (CABAC), variable length coding such as context-adaptive variable-length coding (CAVLC), etc.

The video encoder 200 may further include a buffer (e.g., an encoded picture buffer (EPB)) that is connected to an output of the entropy encoder 230. In this example, the encoded bit stream EBS may be buffered in the buffer, and then may be output to an external device.

The reconstruction module 240 may be used to generate a reconstructed picture by decoding the loss-encoded data. The reconstruction module 240 may include an inverse quantization unit 242, an inverse transform unit 244, and an adder 246 that are substantially the same as the inverse quantization unit 132, the inverse transform unit 134 and the adder 136 in FIG. 2, respectively.

Restored data CURD′ corresponding to a decoded block may be stored in the storage 250. The decoded block may be generated by encoding the current block and decoding the encoded block. The data CURD′ may be used as another reference picture for encoding the other pictures.

Although not illustrated in FIG. 8, the video encoder 200 may further include a deblocking filter and/or a sample adaptive offset filter located between the adder 246 and the storage 250.

FIG. 9 is a flow chart illustrating an example of generating an encoded block in FIG. 7.

Referring to FIGS. 7 and 9, to generate the encoded block by encoding the current block based on applying the IC operation to the current block (e.g., in operation S270), a predicted block may be generated by performing a prediction operation based on a reference block and IC parameters (S271). The reference block may be included in a reference picture and may correspond to the current block. The IC parameters may be set by applying the IC operation to the current block. For example, the IC operation may be applied to the reference block based on the IC parameters, and the prediction operation may be performed based on the IC-applied reference block. As a result, the predicted block corresponding to the IC-applied current block may be generated.

A residual block may be generated by subtracting the predicted block from the current block (S273), and the encoded block may be generated by transforming and quantizing the residual block (S275).

In some example embodiments, operation S271 may be performed by the prediction and mode decision module 210 in FIG. 8, and operations S273 and S275 may be performed by the compression module 220 in FIG. 8.

FIG. 10 is a block diagram illustrating a video encoding and decoding system according to an exemplary embodiment.

Referring to FIG. 10, a video encoding and decoding system 500 may include a first device 510 and a second device 520. The first device 510 may communicate with the second device 520 via a channel 530. For example, the channel 530 may include a wired channel and/or a wireless channel.

The first device 510 and the second device 520 may be referred to as a source device and a destination device, respectively. Some elements of the first and second devices 510 and 520 that are irrelevant to an operation of the video encoding and decoding system 500 are omitted in FIG. 10 for convenience of illustration.

The first device 510 may include a video source (SRC) 512, a video encoder 514 and a transmitter (TX) 516. The video source 512 may provide video data. The video encoder 514 may encode the video data. The transmitter 516 may transmit the encoded video data to the second device 520 via the channel 530.

The second device 520 may include a receiver (RX) 522, a video decoder 524 and a display device (DISP) 526. The receiver 522 may receive the encoded video data transmitted from the first device 510. The video decoder 524 may decode the encoded video data. The display device 526 may display a video or an image based on the decoded video data.

The video decoder 524 may perform the decoder-side IC operation based on the method of decoding the video data according to example embodiments. The video encoder 514 may provide neighboring pixel information to the video decoder 524 based on the method of encoding the video data according to example embodiments such that the video decoder 524 performs the decoder-side IC operation.

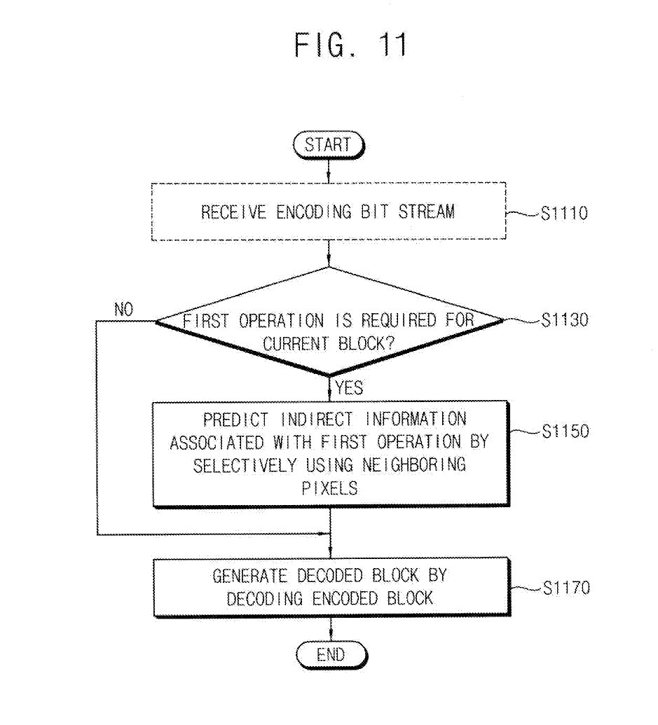

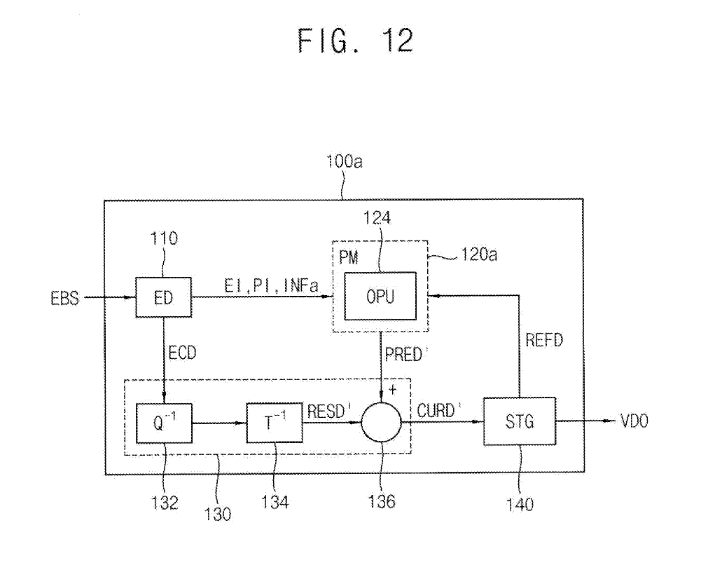

FIG. 11 is a flow chart illustrating a method of decoding video data according to an exemplary embodiment.

Referring to FIG. 11, in a method of decoding video data according to example embodiments, it is determined whether a first operation is required for a current block included in a current picture (S1130). The first operation represents an operation where a decoder-side derivation operation is requested. For example, the first operation may include a decoder-side motion vector derivation, a decoder-side intra prediction direction derivation, a decoder-side chroma prediction signal derivation using luma prediction signal, a decoder-side interpolation filter coefficient derivation, a decoder-side in-loop filtering coefficient derivation, etc.

When the first operation is required for the current block (1130: YES), indirect information (e.g., prediction, interpolation, derived information, secondary information, etc.) may be predicted by selectively using a plurality of neighboring pixels based on pixel usage information that is received from an external device (e.g., from a video encoder) (S1150). The plurality of neighboring pixels may be located adjacent to the current block. The indirect information may be associated with the first operation, and may be information that is not directly associated with the first operation. For example, if the first operation is the decoder-side motion vector derivation, the predicted indirect information may not be a motion vector. As another example, if the first operation is the decoder-side intra prediction direction derivation, the predicted indirect information may not be an intra prediction indicator.

A decoded block may be generated by decoding an encoded block based on the predicted indirect information (S1170). For example, if the first operation is the decoder-side motion vector derivation, the motion vector may be determined based on the predicted indirect information, and then the decoding operation may be performed based on the determined motion vector. As another example, if the first operation is the decoder-side intra prediction direction derivation, the intra prediction indicator may be determined based on the predicted indirect information, and then the decoding operation may be performed based on the determined intra prediction indicator.

In some example embodiments, before step S1130, an encoded bit stream including the encoded block, first information, and second information may be received (S1110), and then operations S1130, S1150, and S1170 may be performed based on the encoded bit stream. The first information may be information representing whether the first operation is performed for the current block. The second information may be information on pixels that are included in the plurality of neighboring pixels and are used for performing the first operation for the current block. As described with reference to FIGS. 3A, 3B, 3C, and 3D, and Tables 1, 2, 3 and 4, arrangements and implementations of the first and second information may vary according to example embodiments.

When the first operation is not required for the current block (S1130: NO), operation S1150 may be omitted, and then a decoded block may be generated by decoding the encoded block without the indirect information.

When various operations where the decoder-side derivation operation is requested are performed, at least some of the neighboring pixels that are located adjacent to the current block may be selectively used. Accordingly, the video decoder that performs such method according to example embodiments may achieve improved coding efficiency and a simpler structure.

FIG. 12 is a block diagram illustrating a video decoder according to an exemplary embodiment.

Referring to FIG. 12, a video decoder 100a may include a prediction module 120a and a reconstruction module 130. The video decoder 100a may further include an entropy decoder 110 and a storage 140.

The video decoder 100a of FIG. 12 may be substantially the same as the video decoder 100 of FIG. 2, except that the prediction module 120a in FIG. 12 is different from the prediction module 120 in FIG. 2. The video decoder 100a may perform the method of decoding the video data of FIG. 11 and may perform any operation where the decoder-side derivation operation is requested.

The prediction module 120a may determine whether the first operation is required for a current block included in a current picture, and predict indirect information by selectively using a plurality of neighboring pixels based on pixel usage information when the first operation is required for the current block. The indirect information is associated with the first operation, and the plurality of neighboring pixels may be located adjacent to the current block. The prediction module 120a may include an operation performing unit (OPU) 124. The operation performing unit 124 may determine based on first information EI whether the first operation is required for the current block, and may predict the indirect information based on second information PI. The first information EI may be information representing whether the first operation is performed for the current block. The second information PI may be information representing used pixels that are included in the plurality of neighboring pixels and are used for performing the first operation for the current block.

The prediction module 120a may perform a prediction operation based on data REFD corresponding to a reference block and the predicted indirect information to generate data PRED′ corresponding to a predicted block. For example, if the first operation is the decoder-side motion vector derivation, coding information INFa in FIG. 12 may not include a motion vector. In this example, the operation performing unit 124 may be included in a motion compensation unit in the prediction module 120a, the motion vector may be determined based on the predicted indirect information, and then the predicted block may be generated based on the determined motion vector and the reference block. As another example, if the first operation is the decoder-side intra prediction direction derivation, the coding information INFa in FIG. 12 may not include an intra prediction indicator. In this example, the operation performing unit 124 may be included in an intra prediction unit in the prediction module 120a, the intra prediction indicator may be determined based on the predicted indirect information, and then the predicted block may be generated by performing the prediction operation based on the determined intra prediction indicator.

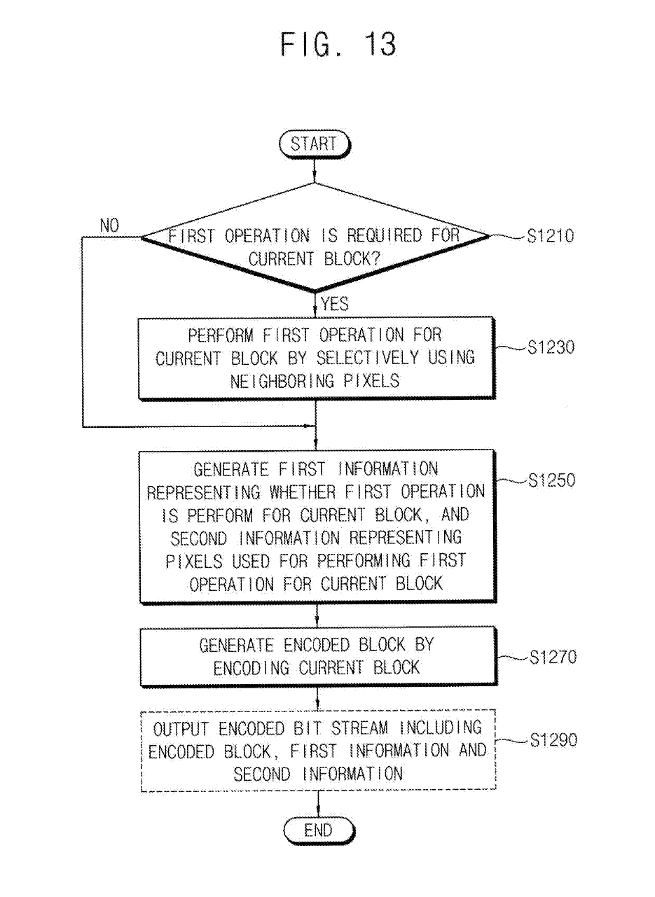

FIG. 13 is a flow chart illustrating a method of encoding video data according to an exemplary embodiment.

Referring to FIG. 13, it may be determined whether a first operation is required for a current block included in a current picture (S1210). The first operation may represent an operation where a decoder-side derivation operation is requested. As described with reference to FIG. 11, the first operation may include a decoder-side motion vector derivation, a decoder-side intra prediction direction derivation, a decoder-side chroma prediction signal derivation using luma prediction signal, a decoder-side interpolation filter coefficient derivation, a decoder-side in-loop filtering coefficient derivation, etc.

When it is determined that the first operation is required for the current block (S1210: YES), the first operation may be performed for the current block by selectively using a plurality of neighboring pixels (S1230). The plurality of neighboring pixels may be located adjacent to the current block. For example, if the first operation is the decoder-side motion vector derivation, a motion vector may be determined by selectively using at least some of the plurality of neighboring pixels. As another example, if the first operation is the decoder-side intra prediction direction derivation, an intra prediction indicator may be determined by selectively using at least some of the plurality of neighboring pixels.

First information and second information may be generated (S1250), and an encoded block may be generated by encoding the current block based on performing the first operation for the current block (step S1270). The first information is information representing whether the first operation is performed for the current block. The second information is information representing used pixels that are included in the plurality of neighboring pixels and are used for performing the first operation for the current block. As described with reference to FIGS. 3A, 3B, 3C and 3D, and Tables 1, 2, 3 and 4, arrangements and implementations of the first and second information may vary according to example embodiments.

In some example embodiments, after step S1270, an encoded bit stream including the encoded block, the first information and the second information may be output (S1290). In other words, only the encoded block, the first information and the second information may be output, without information that is directly associated with the first operation.

When it is determined that the first operation is not required for the current block (S1210: NO), operation S1230 may be omitted, and then an encoded block may be generated by encoding the current block where the first operation is not performed therefor.

When various operations where the decoder-side derivation operation is requested are performed, information that is directly associated with the decoder-side derivation operation may not be output or provided, and information associated with the neighboring pixels may only be output such that the decoder-side derivation operation is performed by the video decoder. Since at least some of the neighboring pixels are selectively used when the decoder-side derivation operation is performed for the current block, the video encoder that performs such method according to example embodiments may have relatively improved coding efficiency and relatively simple structure.

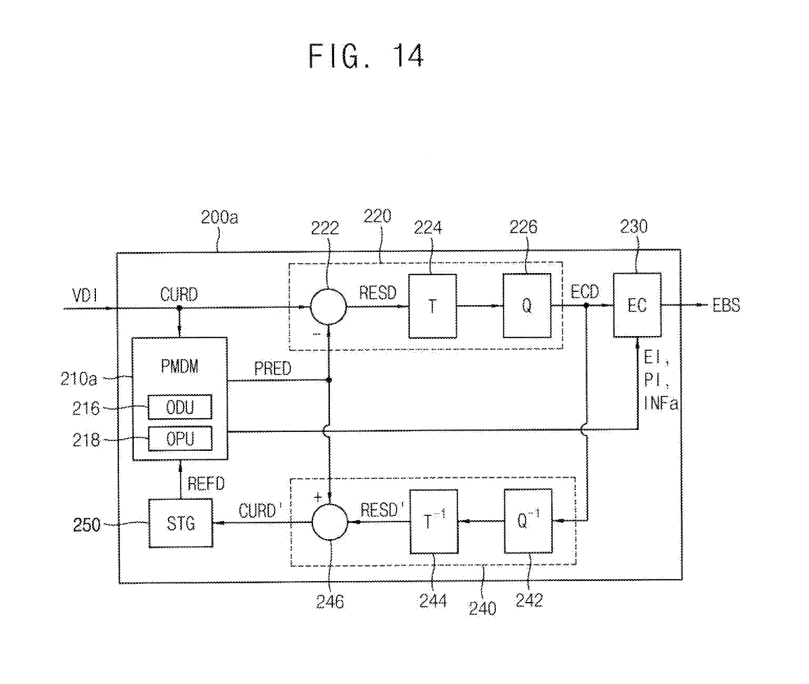

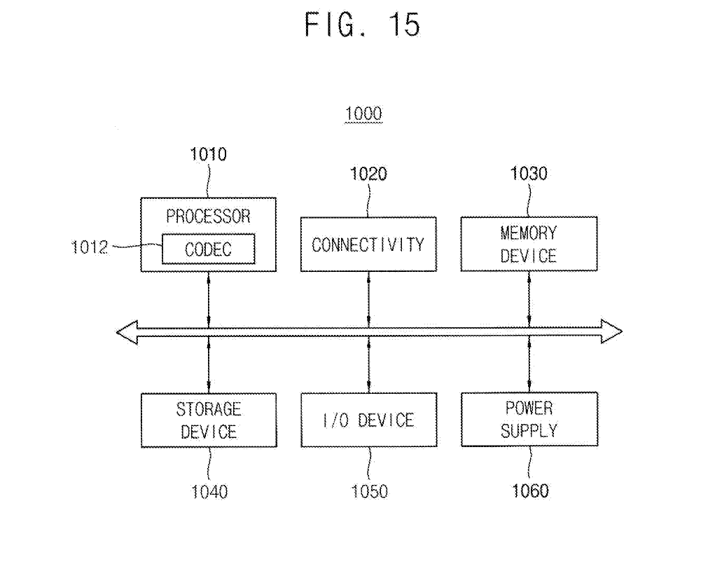

FIG. 14 is a block diagram illustrating a video encoder according to an exemplary embodiment.

Referring to FIG. 14, a video encoder 200a may include a prediction and mode decision module (PMDM) 210a and a compression module 220. The video encoder 200a may further include an entropy encoder (EC) 230, a reconstruction module 240 and a storage 250.

The video encoder 200a of FIG. 14 may be substantially the same as the video encoder 200 of FIG. 8, except that the prediction and mode decision module 210a in FIG. 14 is different from the prediction and mode decision module 210 in FIG. 8. The video encoder 200a may perform the method of encoding the video data of FIG. 13 and may generate information for performing any operation where the decoder-side derivation operation is requested.

The prediction and mode decision module 210a may determine whether the first operation is required for a current block included in a current picture. When the first operation is required for the current block, the prediction and mode decision module 210a may perform the first operation for the current block by selectively using a plurality of neighboring pixels that are located adjacent to the current block. The prediction and mode decision module 210a may include an operation determining unit (ODU) 216 and an operation performing unit 218. The operation determining unit 216 may determine whether the first operation is required for the current block and may generate first information EI. The first information EI may be information representing whether the first operation is performed for the current block. The operation performing unit 218 may perform the first operation for the current block by selectively using the plurality of neighboring pixels and may generate second information PI. The second information PI may be information on pixels that are included in the plurality of neighboring pixels and are used for performing the first operation for the current block. As described with reference to FIGS. 11 and 12, when an encoded block that is generated by encoding the current block is to be decoded, indirect information associated with the first operation may be predicted by a video decoder (e.g., the video decoder 100a of FIG. 12) based on the second information PI.

The prediction and mode decision module 210a may perform a prediction operation based on data REFD corresponding to a reference block and a result of the first operation to generate data PRED corresponding to a predicted block and coding information INFa. For example, if the first operation is the decoder-side motion vector derivation, the coding information INFa in FIG. 14 may not include a motion vector. In this example, the operation determining unit 216 and the operation performing unit 218 may be included in a motion estimation unit and a motion compensation unit in the prediction and mode decision module 210a, respectively. For another example, if the first operation is the decoder-side intra prediction direction derivation, the coding information INFa in FIG. 14 may not include an intra prediction indicator. In this example, the operation determining unit 216 and the operation performing unit 218 may be included in an intra estimation unit and an intra prediction unit in the prediction and mode decision module 210a, respectively.

Various exemplary embodiments of the present disclosure may be embodied as a system, a method, a computer program product, and/or a computer program product embodied in one or more computer-readable medium(s) having computer-readable program code embodied thereon. The computer readable program code may be provided to a processor of a general purpose computer, a special purpose computer, or other programmable data processing apparatus. The computer-readable medium may be a computer readable signal medium or a computer-readable storage medium. The computer-readable storage medium may be any tangible medium that can contain, or store a program for use by or in connection with an instruction execution system, apparatus, or device. For example, the computer-readable medium may be a non-transitory computer-readable medium.

The video encoder and the video decoder may be merged in the same integration circuit and/or corresponding software, and then the merged device may be referred to as a video coder/decoder (codec). For example, in the video codec, the entropy encoder 230 and the entropy decoder 110 may be merged, and the prediction and mode decision module 210 and the prediction module 120 may be merged. In addition, each of the inverse quantization units 132 and 242, the inverse transform units 134 and 244, the adders 136 and 246, and the storages 140 and 250 may be also merged, respectively.

FIG. 15 is a block diagram illustrating an electronic system according to an exemplary embodiment.

Referring to FIG. 15, an electronic system 1000 may include a processor 1010, a connectivity module 1020, a memory device 1030, a storage device 1040, an input/output (I/O) device 1050, and a power supply 1060. One or more of these modules and devices may be connected to each other via a bus.

The processor 1010 may perform various computational functions such as calculations and tasks. A video codec 1012 may include a video encoder/decoder and may perform a method of encoding/decoding video data according to example embodiments. The video encoder and the video decoder may be merged in the video codec 1012. The method of encoding/decoding video data according to example embodiments may be performed by instructions (e.g., a software program) that are executed by the video codec 1012 or by hardware implemented in the video codec 1012. The video codec 1012 may be located inside or outside the processor 1010.

The connectivity module 1020 may communicate with an external device and may include a transmitter and/or a receiver. The memory device 1030 and the storage device 1040 may operate as a data storage for data processed by the processor 1010, or as a working memory. The I/O device 1050 may include at least one input device such as a keypad, a button, a microphone, a touch screen, etc., and/or at least one output device such as a speaker, a display device, etc. The power supply 1060 may provide power to the electronic system 1000.

The present disclosure may be applied to various devices and/or systems that encode and/or decode video data. Particularly, some example embodiments of the inventive concept may be applied to a video encoder that is compatible with standards such MPEG, H.261, H.262, H.263 and H.264. Some example embodiments may be adopted in technical fields such as cable TV (CATV) on optical networks, copper, etc., direct broadcast satellite (DBS) video services, digital subscriber line (DSL) video services, digital terrestrial television broadcasting (DTTB), interactive storage media (ISM) (e.g., optical disks, etc.), multimedia mailing (MMM), multimedia services over packet networks (MSPN), real-time collaboration (RTC) services (e.g., videoconferencing, videophone, etc.), remote video surveillance (RVS), serial storage media (SSM) (e.g., digital video recorder, etc.).

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1. A method of decoding video data in units of blocks, the method comprising:
determining whether an illumination compensation (IC) operation is applied to a current block included in a current picture;
predicting IC parameters by selectively using a plurality of neighboring pixels when the IC operation is applied to the current block, the IC parameters being used for applying the IC operation to the current block, the plurality of neighboring pixels being located adjacent to the current block; and
generating, via a processor, a decoded block by decoding an encoded block based on the predicted IC parameters, the encoded block being generated by encoding the current block.

2. The method of claim 1, further comprising:
receiving an encoded bit stream including:
the encoded block,
first information representing whether the IC operation is applied to the current block, and
second information on pixels that are included in the plurality of neighboring pixels and are used for applying the IC operation to the current block,
wherein whether the IC operation is applied to the current block is determined based on the first information, and
wherein the IC parameters are predicted based on the second information.

3. The method of claim 2, wherein the second information includes first usage information representing whether first neighboring pixels in the plurality of neighboring pixels are used for applying the IC operation to the current block, and second usage information representing whether second neighboring pixels in the plurality of neighboring pixels are used for applying the IC operation to the current block,
wherein the first neighboring pixels are located adjacent to a first side of the current block, and
wherein the second neighboring pixels are located adjacent to a second side of the current block.

4. The method of claim 2, wherein the second information includes number information representing a number of the pixels that are used for applying the IC operation to the current block, and location information representing locations of the pixels that are used for applying the IC operation to the current block.

5. The method of claim 2, wherein the first information and the second information are included in a block header representing coding information of the current block, and
wherein the block header is included in the encoded bit stream.

6. The method of claim 2, wherein the first information and the second information are included in one of a picture parameter set and a sequence parameter set, representing coding information of the current picture, and
wherein the picture parameter set and the sequence parameter set are included in the encoded bit stream.

7. The method of claim 1, wherein the generating the decoded block comprises:
generating a predicted block by performing a prediction operation based on a reference block and the predicted IC parameters, the reference block being included in a reference picture and corresponding to the current block;
generating a residual block by inverse-quantizing and inverse-transforming the encoded block; and
generating the decoded block by adding the residual block to the predicted block.

8.-10. (canceled)

11. A method of encoding video data in units of blocks, the method comprising:
determining whether an illumination compensation (IC) operation is required for a current block included in a current picture;
applying the IC operation to the current block by selectively using a plurality of neighboring pixels when the IC operation is required for the current block, the plurality of neighboring pixels being located adjacent to the current block;
generating first information representing whether the IC operation is applied to the current block, and second information representing pixels that are included in the plurality of neighboring pixels and are used for applying the IC operation to the current block; and
generating an encoded block by encoding the current block based on applying the IC operation to the current block.

12. The method of claim 11, wherein the second information includes first usage information representing whether first neighboring pixels included in the plurality of neighboring pixels are used for applying the IC operation to the current block, and second usage information representing whether second neighboring pixels included in the plurality of neighboring pixels are used for applying the IC operation to the current block,
wherein the first neighboring pixels are located adjacent to a first side of the current block, and
wherein the second neighboring pixels are located adjacent to a second side of the current block.

13. The method of claim 11, wherein the second information includes number information representing a number of the pixels that are used for applying the IC operation to the current block, and location information representing locations of the pixels that are used for applying the IC operation to the current block.

14. The method of claim 11, wherein the first information and the second information are included in a block header representing coding information of the current block.

15. The method of claim 11, wherein the first information and the second information are included in one of a picture parameter set and a sequence parameter set, representing coding information of the current picture.

16. The method of claim 11, wherein the generating the encoded block comprises:
generating a predicted block by performing a prediction operation based on a reference block and IC parameters, the reference block being included in a reference picture and corresponding to the current block, the IC parameters being set based on applying the IC operation to the current block;
generating a residual block by subtracting the predicted block from the current block; and
generating the encoded block by transforming and quantizing the residual block.

17. The method of claim 16, wherein the IC parameters are predicted based on the second information when the encoded block is to be decoded.

18. The method of claim 11, further comprising:
outputting an encoded bit stream including the encoded block, the first information, and the second information.

19.-27. (canceled)

28. A method comprising:
receiving, at a decoder comprising a processor, an encoded bit stream of a video divided into a plurality of blocks;
extracting, from the encoded bit stream:
encoded block data corresponding to a first block in a first frame of the video,
a first metadata indicating whether an illumination compensation (IC) operation is applied to the first block,
a second metadata indicating pixels in the first frame that are adjacent to the first block, and
a third metadata indicating a prediction operation mode;
based on the first metadata, determining whether the IC operation is applied to the first block;
based on the second metadata and a second block of a second frame preceding the first frame in the video, estimating parameters for the IC operation by referencing the pixels in the first frame that are adjacent to the first block, wherein the second block is a reference block corresponding to the first block;
generating a predicted block corresponding to the first block by applying the IC operation to the second block based on the estimated parameters and performing a prediction operation based on the third metadata and the second block;
applying the IC operation to the first block; and
generating a decoded block data by decoding the encoded block data based on the predicted block.

29. The method of claim 28, wherein the third metadata further indicating at least one of a result of a prediction operation and a syntax element.

30. The method of claim 28, wherein the prediction operation mode is one of an intra prediction mode for predicting without reference to other frames in the video and an inter prediction mode for predicting with reference to at least one of the other frames in the video.

31. The method of claim 28, wherein the pixels indicated by the second metadata correspond to only a partial list of pixels that are adjacent to the first block.

32. The method of claim 28, wherein the estimated parameters for the IC operation comprise at least a scaling factor and an offset.

33.-35. (canceled)
